(19) United States
(12) Patent Application Publication
(10) Pub. No.: US 2025/0173408 A1
(43) Pub. Date: May 29, 2025

(54) METHOD, SYSTEM AND COMPUTER PROGRAM FOR REGISTERING A USER WITH A THIRD-PARTY SERVICE

(71) Applicant: Paycasso Verify Ltd, London (GB)

(72) Inventors: Russell Stuart KING, London (GB); Andries INZÉ, London (GB)

(21) Appl. No.: 18/934,176

(22) Filed: Oct. 31, 2024

Related U.S. Application Data
(63) Continuation of application No. 17/772,103, filed on Apr. 26, 2022, now abandoned.

(30) Foreign Application Priority Data
Oct. 27, 2019 (GB) 1915570.4
Apr. 23, 2020 (GB) 2005945.7

(51) Int. Cl. G06F 21/31; G06F 16/955; H04L 9/40

(52) U.S. Cl. CPC G06F 21/31; G06F 16/955; H04L 63/08; H04L 63/0853

(57) ABSTRACT

A method of registering a user with a third-party service using an identity verification process, comprising receiving configuration data from the third-party service. The configuration data comprises a user number associated with the user of the third-party service; and application data associated with the third-party service. The configuration data is used to generate a uniform resource identifier, URI, for an application associated with the identity verification process, distributing the URI to a device associated with the user; and receiving a notification from the device indicating that the user has accessed the URI. In response to receiving the notification, at least part of the configuration data is sent to configure the application on the device in order for the user to perform the identity verification process, associated with the third-party service, to register with the third-party service.

### CROSS-REFERENCE TO RELATED APPLICATIONS

This application is a continuation under 35 U.S.C. § 120 of U.S. application Ser. No. 17/772,103, filed Apr. 26, 2022, which is a 371 National Phase application of International Application No. PCT/GB2020/052717, filed Oct. 27, 2020, which claims priority to United Kingdom Application No. GB 1915570.4, filed Oct. 27, 2019 and United Kingdom Application No. GB 2005945.7, filed Apr. 23, 2020 under 35 U.S.C. § 119 (a). Each of the above-referenced patent applications is incorporated by reference in its entirety.

### TECHNICAL FIELD

Embodiments disclosed herein relate to a method, system and computer program for registering a user with a third-party service using an identity verification process.

### BACKGROUND

There is growing demand for service providers to provide their services via devices, such as PCs, tablets and mobile phones. For many service providers, the need to verify the credentials of the users to whom they are providing a service is very important. For example, online banking service providers need to ensure that the identity of a user is reliably verified before that user is allowed to register for such banking services. There are particular challenges for service providers to provide an identity verification process that is specific to their user, in order for the requirements for registration to be met.

### SUMMARY

According to a first aspect of the present disclosure, there is provided a method of registering a user with a third-party service using an identity verification process. The method comprising: receiving first configuration data from the third-party service, wherein the first configuration data comprises: a user number associated with the user of the third-party service; and application data associated with the third-party service; using the first configuration data to generate a URI for an application associated with the identity verification process; distributing the URI to a device associated with the user; receiving a notification from the device indicating that the user has accessed the URI; and responsive to the notification, sending at least part of the first configuration data to configure the application on the device in order for the user to perform the identity verification process, associated with the third-party service, to register with the third-party service.

According to a second aspect of the present disclosure, there is provided a method of using an identity verification process associated with a service to register a user with a third-party service. The method comprising: sending first configuration data to the service, wherein the first configuration data comprises: a user number associated with the user of the third-party service; and application data associated with the third-party service; receiving a URI from the service, wherein the URI is for an application associated with the identity verification process; and providing the URI to a device associated with the user in order for the user to perform the identity verification process, associated with the third-party service, to register with the third-party service.

### BRIEF DESCRIPTION OF THE DRAWINGS

FIG. 1 is a schematic diagram of a first captured image according to examples disclosed herein;

FIG. 2 is a schematic diagram of a second captured image according to examples disclosed herein;

FIG. 3 is a schematic diagram of a device configured to carry out a method according to an embodiment of the present disclosure;

FIG. 4 is a schematic diagram of navigating a user to an identity verification process according to examples disclosed herein;

FIG. 5 is a schematic diagram of configuring an application associated with an identity verification process according to examples disclosed herein;

FIGS. 6a and 6b are schematic diagrams illustrating a method for registering a user with a third-party service according to examples disclosed herein;

FIG. 7 is a flow diagram illustrating a method for registering a user with a third-party service according to examples disclosed herein;

FIG. 8 is a flow diagram illustrating a method for generating a URI associated with an application according to examples disclosed herein;

FIG. 9 is a schematic diagram illustrating a method for configuring an application associated with an identity verification process according to examples disclosed herein;

FIG. 10 is a flow diagram illustrating a method for retrieving configuration data according to examples disclosed herein;

FIG. 11 is a flow diagram illustrating a method performed by a third-party service according to examples disclosed herein; and

FIG. 12 is a flow diagram illustrating a method performed by a device associated with user of a third-party service according to examples disclosed herein.

### DETAILED DESCRIPTION

A conventional way of verifying the identity and/or credentials of a person is to ask that person to provide documentation that supports their identity and/or credentials. For example, a person may be asked to provide a valid photographic ID, such as a passport or driving license as proof of their identity. In this case, in order to verify that person's identity, typically two separate checks are performed. Firstly, the validity of the photographic ID is checked and secondly the person providing the photographic ID is compared to the image on the photographic ID in order to verify that the photographic ID belongs to that person. Typically, these checks are performed by a human.

There are known techniques for checking the validity of an identity document, such as a photographic ID, via a device. For example, by configuring a device to look for certain features in an image, it is possible to verify, up to a reasonable level of certainty, via a device, whether an image of an identity document is an image of a valid identity document. Such features may include, for example, the inclusion of certain check digits within machine readable zones on the identity document (which can be read by a device using optical character recognition (OCR) techniques), or the inclusion of an image of a human face that is located in an expected position relative to other features of the document. Other features may include, for example, the presence of a tag, label or chip within the identity document, which can be read by a radio frequency identification technique to automatically collect encoded data stored on the tag/label. The encoded data may contain, for example, a digital image of a human face and/or other biometric information e.g. the relative position, size and/or shape of the eyes, nose, cheekbones and jaw. Other validity indicators for the identity document include, for example, the inclusion of water marks or holograms, and the use of particular fonts.

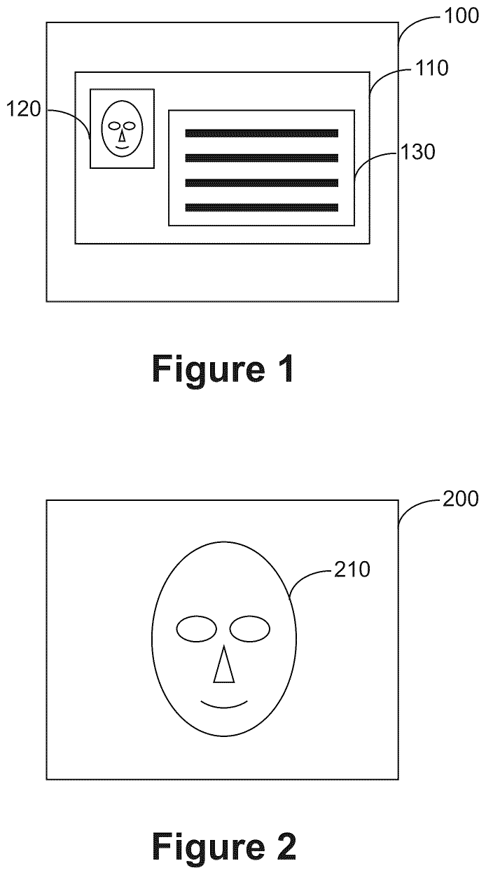

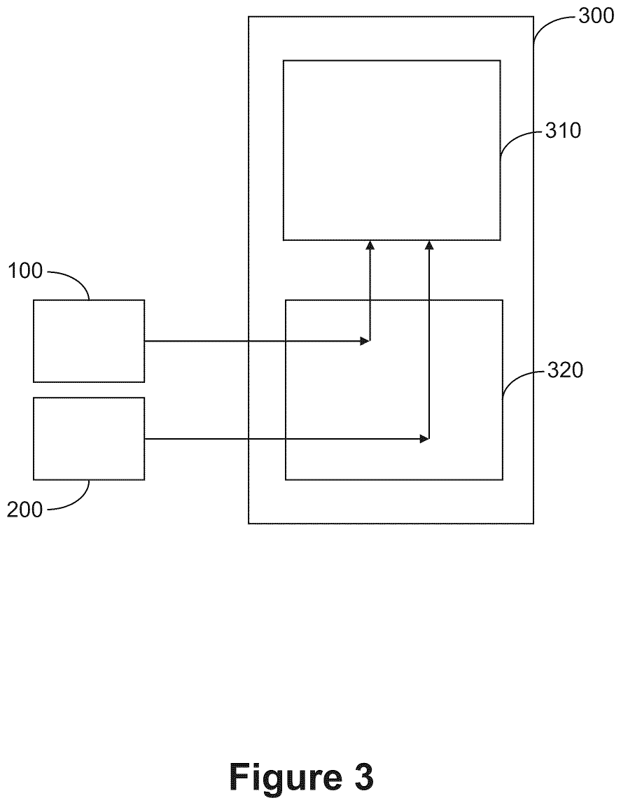

By comparing the face of a user of a device to the picture of a human face on a photographic ID held by the user of the device, it is possible to authenticate the user of the device in this way. By configuring a device to capture an image of the user of the device, and an image of an identity document held by the user of the device, and comparing the image of the user of the device to the picture of the human face on the identity document, it can be determined whether they represent the same entity. FIGS. 1 and 2 show examples of two such captured images 100, 200.

FIG. 1 is a schematic diagram of a first image 100. The first image 100 is an image of an identity document 110, which is associated with a person. The identity document 110 contains a picture 120 of the person associated with the identity document 110. Typically, an identity document 110 will include details 130 which can be used to identify the identity and/or other credentials of the person associated with the identity document 110. Identity documents are typically issued by a trusted authority, such as the Government, for example. Such a trusted authority will have previously verified that the picture 120 is a picture of the person associated with the identity document 110 and will have authenticated that person as the person associated with the details 130. The identity document may be a physical document, such as an identity card, passport or certificate, or it may be an electronic document, such as a digital photograph and associated identity data stored on a chip. The identity document may be a physical document comprising a tag, label or chip that contains encoded data. Using techniques such as radio frequency identification, the encoded data (such as a digital photograph and associated identity or biometric information) can be automatically collected and used to verify the identity of the person associated with the identity document. The identity document 110 may contain information on both sides, for example a photocard driving licence may contain personally identifiable information details 130, such as name, address, unique identification number, and a picture 120 on the first side. The second side may contain further information such as the types of vehicles that person is able to legally drive. It will be appreciated that other types of documents may also have information presented on both sides.

FIG. 2 is a schematic diagram of a second image 200. The second image 200 is an image of the user 210 of a device, which has been captured e.g. by a camera on the device. By comparing the first and second images 100, 200, it is possible to verify whether the user 210 of the device, at the time that the second image 200 was captured, is the person associated with the identity document 110. This identity verification process thus allows the identity of the user to be verified.

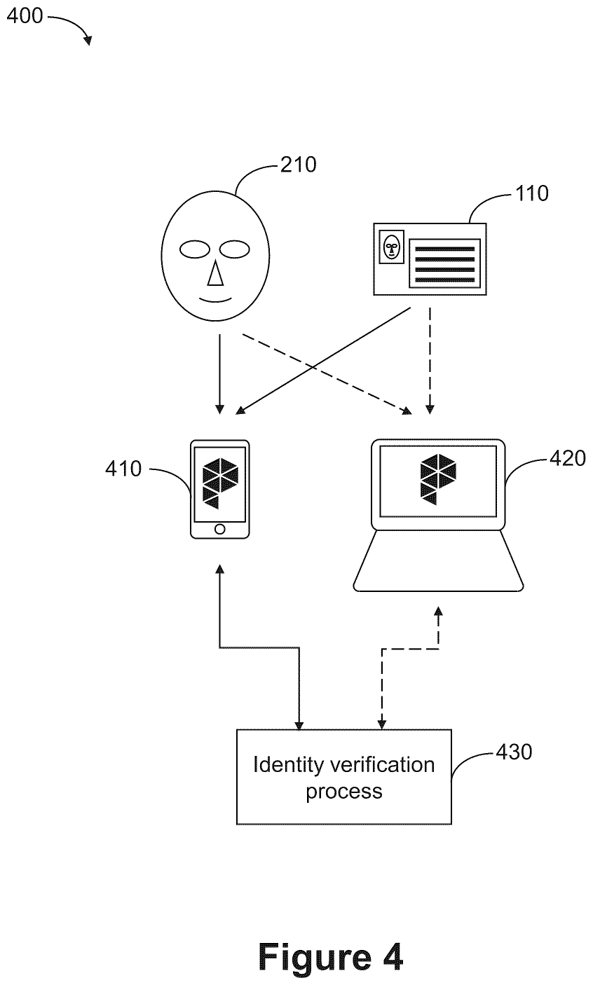

FIG. 3 is a schematic diagram of a device 300 configured to carry out a comparison of a first image 100 and a second image 200 in an identity verification process, associated with an identity verification service. The device 300 may be, for example, a mobile phone, a laptop or a tablet. The device 300, in this example, comprises a processing system 310 and an image capture component 320, such as a camera. The image capture component 310 may be integral with the device 300, or it may be separate from, but communicable with, the device 300.

The device 300 may be configured to capture both a first image 100 of an identity document 110 associated with a previously authenticated user, and a second image 200 of a user 210 of the device 300. These images 100, 200 are provided to the processing system 310, as illustrated schematically by the arrows in FIG. 3. In an alternative arrangement, the processing system 310 may be remote from the device 300, in which case, the device 300 may send the first and second images 100, 200 to the processing system 310 via a wired or wireless network for example. In yet another arrangement, the first image 100 may have previously been captured and stored in a storage device, and the processing system 310 may be arranged to retrieve the first image 100 from the storage device. In other arrangements, the device 300 may be configured to capture a third image (not shown) representing the other side of the identity document 110. In yet a further arrangement a user may be requested to provide more than one document, for example a photographic ID and a utility bill, or even two identity documents which may be compared in the identity verification process.

The processing system 310 is arranged to compare the first image 100 to the second image 200 to determine whether they represent the same user i.e. to determine whether the user 210 represented in the second image 200 is the previously authenticated user associated with the identity document 110. Upon completion of the identity verification process, the identity of the user is either verified (i.e. it is determined that the first image 100 and the second image 200 do represent the same user) or not (i.e. it is determined that the first image 100 and the second image 200 do not represent the same user).

The identity verification process is carried out using an application, arranged to perform the identity verification process, installed or accessible on the device. For example, the identity verification process may be performed by a mobile application installed on a device such as a tablet or mobile phone. In other examples, the identity verification process may be performed by a web application accessible via a web browser on a device such as a laptop, personal computer or mobile phone.

In some arrangements, the identity verification process may obtain further information to aid in the verification of the user. This further information may be obtained from a database on installed or accessible on the device 300, or may be obtained from a databased stored on a remote server. The further information maybe used to assess the veracity of the document. For example, the information in the third image captured representing the reverse of the document maybe obtained and compared to the further information. One such example would be the photocard driving licence mentioned previously, where the reverse of the document details the types of vehicles the licence holder is qualified to drive. This information may be compared with information stored on a remote servers, such as information stored by the relevant licencing authority. If this information matches, then it acts an additional check on the veracity of the document and of the user's identity. It will be appreciated that this may also be used to obtain further information from a second document captured by the user such as a utility bill. Information stored in the second document may also be compared to information in the first document to ensure that the two documents represent the same user. This is also applicable to information captured in a third image representing the other side of the identity document.

In yet a further arrangement, the further information may include location data obtained from the devices, such as via GPS/GLONASS/Galileo. This information may be combined and analysed when performing the identity verification process. For example, access may only be granted when a user is in a particular location. This may provide an additional safeguard against unauthorised use in applications which allow a user to cast their vote in an election. Other hardware in the device may also be utilised to obtain further information. For example, some identity documents contain a chip associated with the identity document which stores identifiers, such as a radio frequency identification (RFID) tags. This information may be obtained via a reader associated with the device such as a built-in reader or external peripheral connected to the device. Again, this further information may be analysed as part of the identity verification process and used when helping to assess the veracity of a particular document.

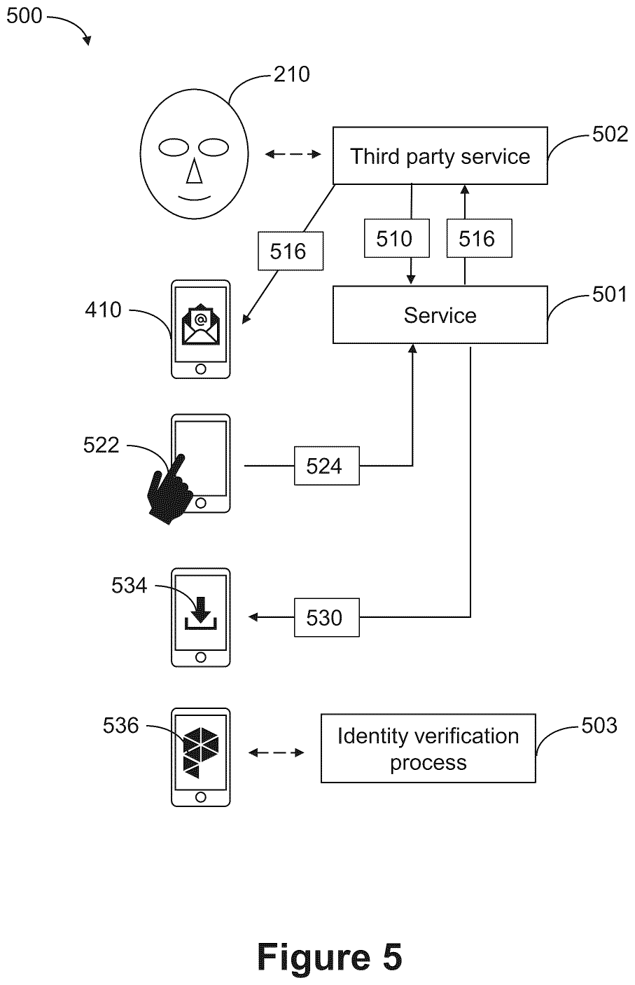

FIG. 4 is a schematic diagram 400 illustrating the steps involved in navigating a user 210 to an identity verification process 430. The identity verification process 430 can be performed by a user 210 on a variety of different internet-enabled devices 410, 420, such as a mobile phone, a laptop, a tablet etc. One such user 210 may have access to a number of devices, such as a mobile phone 410 and a laptop 420.

In one scenario, the user 210 may decide to use a mobile device, such as their mobile phone 410, to carry out the identity verification process 430, as illustrated by the solid arrows of FIG. 4. The mobile phone 410 may have a mobile application (or app) installed on the mobile phone 410, arranged to carry out the identity verification process 430. Receiving a first captured image (such as an image of the identity document 110) and a second captured image (such as an image of the user 210), allows the application on the mobile phone 410 to perform the identity verification process 430 for the user 210.

In another scenario, the user 210 may decide to use a laptop 420, a personal computer or another such device capable of accessing a web browser, to perform the identity verification process 430, as illustrated by the dashed arrows of FIG. 4. The web browser of the laptop 420 may be used to access a web application (or web app) arranged to carry out the identity verification process 430. In a similar manner to that described above, the web application can receive a first captured image (such as an image of the identity document 110) and a second captured image (such as an image of the user 210) to perform the identity verification process 430 for the user 210.

It has been recognised by the present inventors that a service provider, also referred to as a third-party service, may wish to utilise the identity verification process, in order to validate the identity of a user and thus register the user with their third-party service. It has also been recognised by the present inventors that providing a user-specific identity verification process, that is, an identity verification process that is configured specifically for the user of the third-party service, provides the user with a more user-friendly experience. By allowing the third-party service to choose a variety of different configuration options, an identity verification service can provide a bespoke image verification process for each user of the third-party service.

For the third-party service, customising the identity verification process results in the user performing the exact identity verifications required to register with the third-party service. For one third-party service, the user may be required to provide an image of the user and an image of, and/or digital data from, one identity document, such as a passport. For another third-party service, the user may be required to provide an image of the user and images of, and/or digital data from, two identity documents, such as a driving license and an identity card. Dictated by the requirements of the third-party service, the user can experience a customised identity verification process.

In order to perform a user-specific identity verification process, an application used to carry out the identity verification process (for example, a mobile application or a web application) is configured for the user of the third-party service. In examples where the identity verification process is to be performed using a mobile phone, a mobile application may be installed and configured for the identity verification process for the third-party service. In examples where the identity verification process is to be performed using a web browser, a web application may be accessed and configured for the identity verification process for the third-party service.

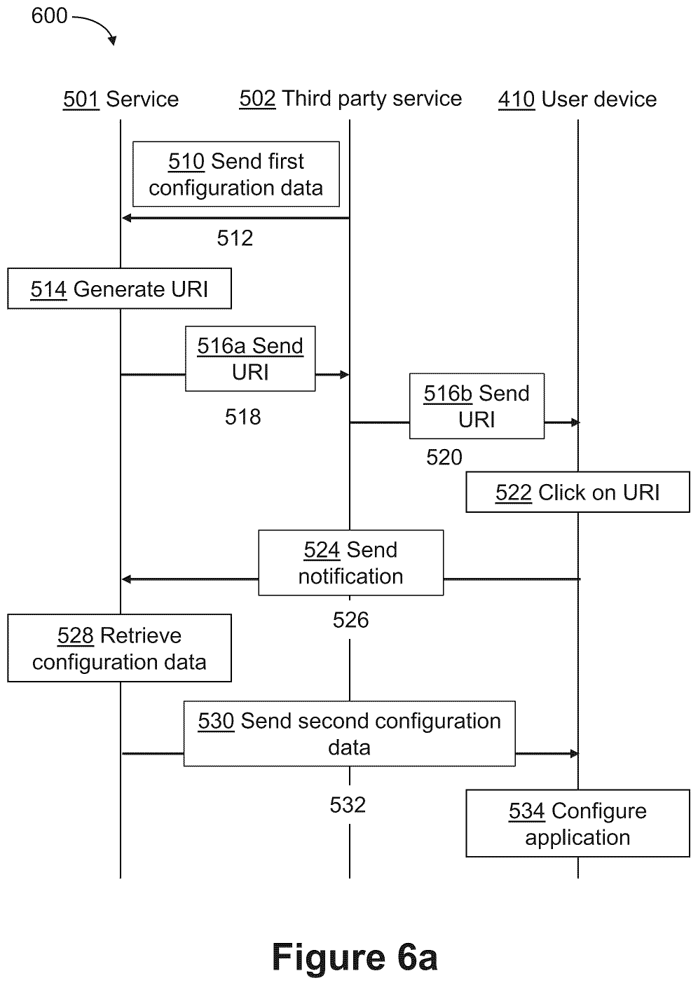

FIG. 5 is a schematic diagram 500 of a method configuring an application according to an embodiment, in order for a user 210 to perform an identity verification process 503. A user 210 may wish to register with a third-party service 502, as illustrated by the dashed lines between the user 210 and the third-party service 502. In order for the user 210 to register with the third-party service 502, the third-party service 502 may require an identity verification process 503 to be performed by the user 210. A service 501, such as an image verification service, can provide such an identity verification process 503, while additionally providing the ability to configure the identity verification process 503 for the third-party service 502. As a result, the user 210 is able to carry out an identity verification process 503 that is configured for the user 210 and the third-party service 502. The identity verification service 501 provides the ability to personalise the identity verification process 503 for the user 210, providing an enhanced user-experience for the registration process.

In order to configure an application for the identity verification process 503, the third-party service 502 sends 510 first configuration data 512 to the identity verification service 501. The identity verification service 501 then generates a uniform resource identifier (URI). After generating the URI, the identity verification service 501 distributes the URI to a device associated with the user. In some arrangements, the identity verification service 501 sends the URI 516 back to the third-party service 502. The third-party service 502 then sends the URI 516 to a device 410 associated with the user 210. In other arrangements, the identity verification service 501 send the URI 516 directly to the device 410 associated with the user 210. FIG. 5 illustrates the device 410 as a mobile phone, but the device could be any device associated with the user (for example, a laptop, a tablet, a personal computer etc.). Once the URI is received by the device 410, the user clicks 522 on the URI to initiate configuration of the application. In some arrangements, the application may be downloaded and installed from a download service, opened and configured on the device. In other arrangements, the application may just be opened and then configured on the device. During the installation and opening of the application, a notification 524 may be sent to the identity verification service 501 to retrieve second configuration data 532. The second configuration data 532 is then sent to the device to configure 534 the application on the device. Using the configured application, the user can then perform 536 the identity verification process 503 on the device 410, in order to register with the third-party service 502.

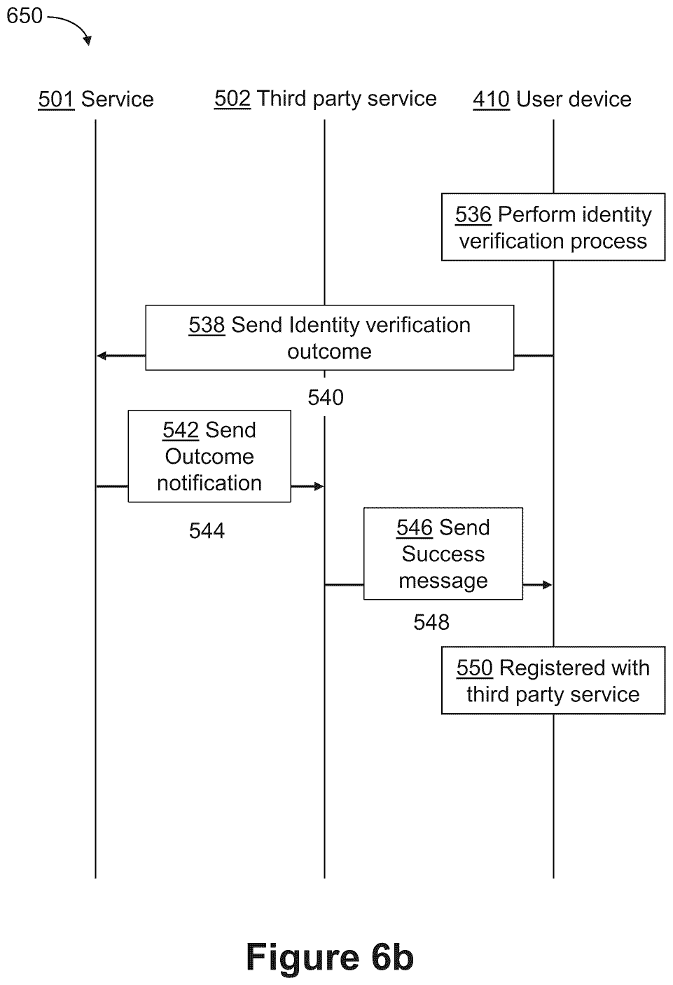

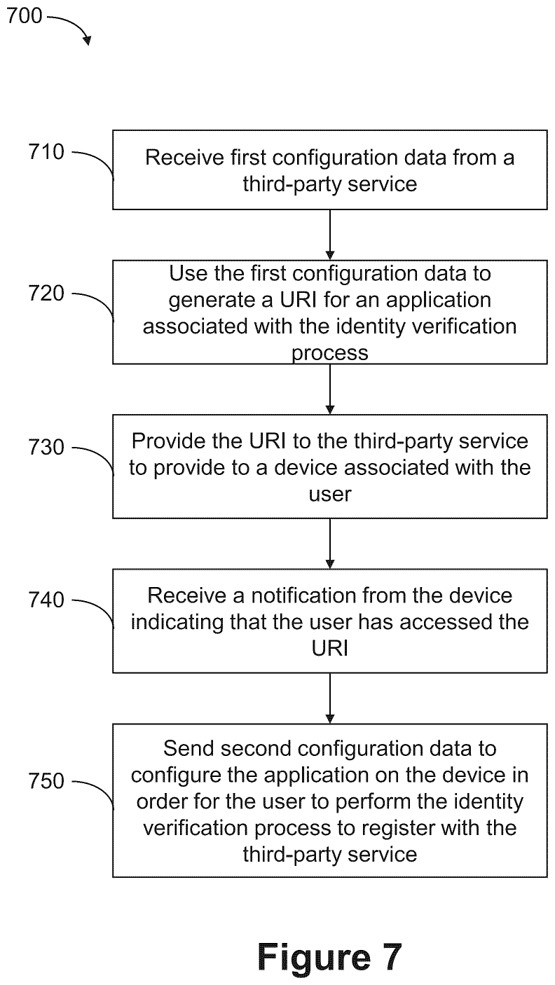

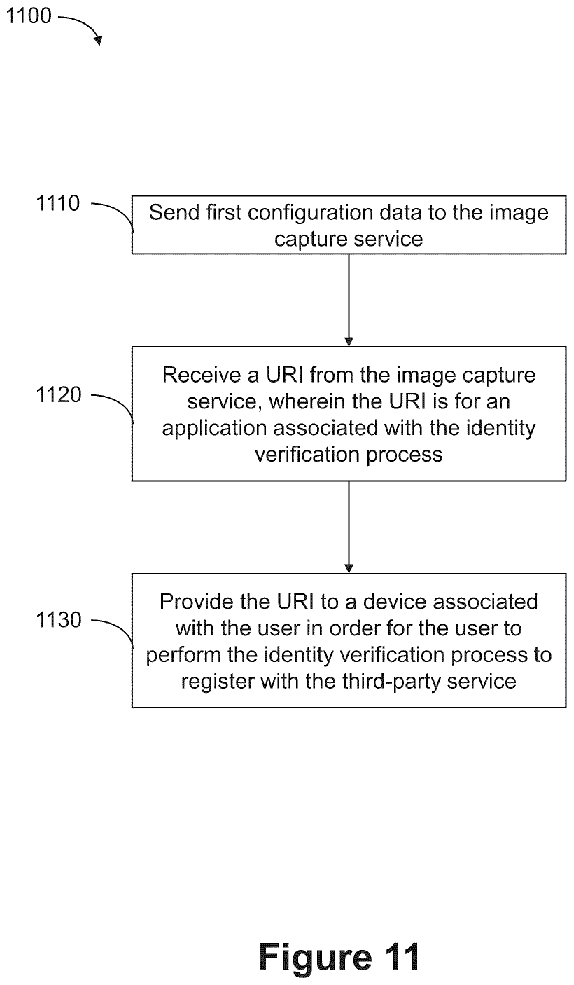

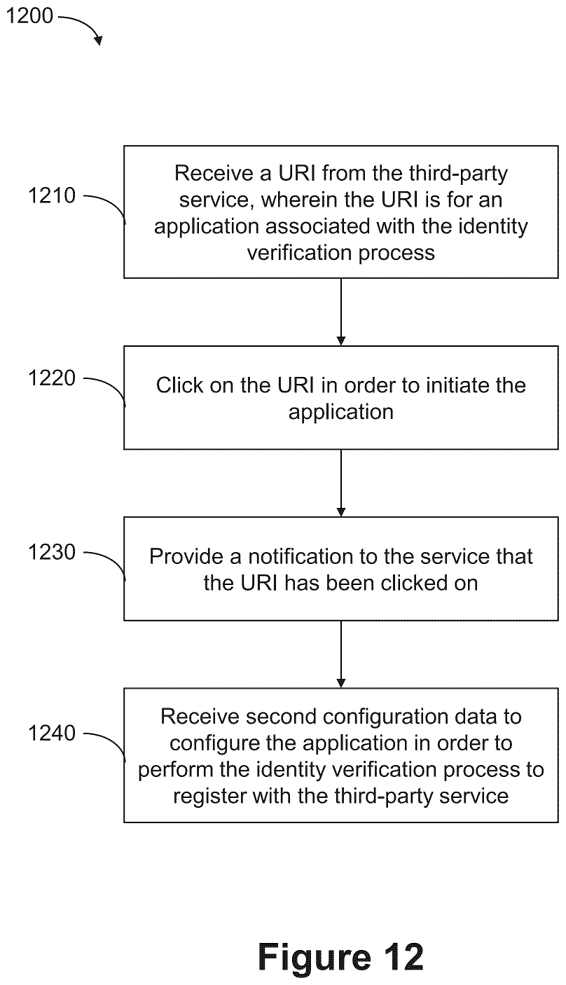

FIGS. 6a and 6b are schematic diagrams 600, 650 illustrating a method for registering a user with a third-party service. For ease of illustration, the features of FIGS. 6a and 6b which are similar to corresponding features of FIG. 5 are labelled with the same reference numeral. FIG. 6a is a schematic diagram 600 for configuring an application, in order for the user to perform an identity verification process. FIG. 6b is a schematic diagram 650 for performing the identity verification process, in order for the user 210 to register with the third-party service 502. Reference numerals 540, 544, 548 indicate messages that are transmitted between a service 501, a third-party service 502 and a device 410 associated with a user. The method performed by the identity verification service 501 is described in more detail with reference to FIGS. 7, 8, 9 and 10. The method performed by the third-party service 502 is described in more detail with reference to FIG. 11. The method performed by the device 410 associated with the user is described in more detail with reference to FIG. 12.

In FIG. 6a, first configuration data 512 that is particular to the user 210 is sent 510 from the third-party service 502 to the service 501. Using the first configuration data 512, a customised uniform resource identifier (URI) is generated 514 by the service 501. The URI is for an application associated with the identity verification process. The URI 518 is then provided 516a from the service 501 to the third-party service 502. Upon receipt of the URI 518 from the service 501, the URI 518 is then provided 516b from third-party service 502 to the device 410 associated with the user. Upon receipt of the URI 518 from the third-party service 502, the user of the device 410 clicks 522 on the URI in order to initiate the application. A notification 526 may then be provided 524 from the device 410 to the service 501. The notification 526 notifies the service 501 that the user has accessed the URI i.e. the URI has been clicked on or the application has been opened. Upon receipt of the notification 526, the service 501 retrieves 528 second configuration data. The second configuration data 532 is then sent 530 from the service 501 to the device 410. Upon receipt of the second configuration data 532, the device 410 configures 534 the application. Configuring the application allows the user to perform the identity verification process, in order to register with the third-party service 502.

In FIG. 6b, the user of the device 410 performs 536 the identity verification process, in order to register with the third-party service 502. As a result of the identity verification process being performed by the user, an identity verification outcome 540 may be sent 538 from the device 410 to the service 501. Upon receipt of the identity verification outcome 540, an outcome notification 544 may be sent 542 from the service 501 to the third-party service 502. The outcome notification 544 notifies the third-party service 502 of the outcome of the identity verification process performed by the user. For example, whether the identity verification process has succeeded, been aborted, been cancelled or failed. If the outcome notification 544 indicates that the identity verification process has succeeded (i.e. the identity of the user has been verified), the third-party service 502 may send 546 a message 548 to the device 410. This message 548 informs the user of the success of the identity verification process. Based on the success of the identity verification process, the user is registered 550 with the third-party service 502. If the outcome notification 544 indicates that the identity verification process has been aborted (i.e. the user has not responded or used the application after a pre-determined time), the third-party service 502 may send 546 a different message to the device 410. This message provides the user with a prompt to continue the identity verification process. If the outcome notification 544 indicates that the identity verification process has been cancelled (i.e. the user has exited the application before the process is complete), the third-party service 502 may send 546 another different message to the device 410. This message provides the user with a prompt to return to return to the application and re-start the identity verification process. Finally, if the outcome notification 544 indicates that the identity verification process has failed (i.e. the identity of the user has not been verified), the third-party service 502 may send another different message to the device 410. This message informs the user of the failure of the identity verification process and provide the user with alternative options on how to proceed. For example, the user may be invited to perform the identity verification process again, perform the identity verification process using a different first captured image and/or second captured image etc.

FIG. 7 is a flow diagram illustrating a method 700 for registering a user with a third-party service using an identity verification process according to an embodiment. The method is performed by a service, such as an identity verification service.

In step 710 of the method 700, first configuration data 512 is received from the third-party service 502. The first configuration data comprises a user number or token associated with the user of the third-party service 502 and application data associated with the third-party service 502. The user number (or token) is preferably sent without any user-specific data (i.e. contact data such as name, mobile phone number, email address, device information etc.). This separation of the user number and the user-specific data maintains the confidentiality and security of the user's data by the third-party service, as all the user-specific data remains with the third-party service 502.

The application data may comprise a logo, welcome message and/or an exit message defined by the third-party service. The logo may be provided as image data (e.g. a digital image file) or a universal resource identifier to a location on a server (associated with the identity verification service or the third-party service) that contains the digital image file. Configuring an application with messages that are specific to the user and/or third-party service may provide the user with a greater degree of confidence in the identity verification process. Furthermore, a user-specific message at the start and/or the end of the process may enhance the experience of the user, due to the personalisation of the process.

The application data may comprise a colourway selection, allowing the application to be configured in one or more colours. The choice of one or more colours can be specified using a format of a standard colour space (e.g. RBG, CMYK etc.) or web colour (e.g. HTML colour names, hex triplet etc.). Configuring an application with a specific colourway that is associated with the third-party service may enhance the connection between the third-party service and the identity verification process.

In some arrangements, the application data may comprise a language choice, allowing the application to be configured in one of a plurality of different languages. Providing a choice of language, in which to render the application, allows the user to perform the identity verification process in the most suitable language for them. The ability to choose the language of the application allows third-party services from around the world to provide an identity verification process that is specific to the users in their country. Providing the option for users to carry out the identity verification process in their native language creates an easier and more convenient user experience.

The application data may comprise an application identifier, which identifies the type of application to be configured. For example, the identity verification service may provide multiple types of applications, each of which can be configured for the third-party service 502. A particular type of application may be requested by the third-party service 502, depending on registration requirements. The type of application may define the number and/or type of captured images (or digital image data) required for the registration process. For example, the registration process may require both the front and back of an identity document, multiple documents, and/or other information associated with the document, such as data stored on a chip of the identity document, or the location data of the device. As such, the application data may comprise the number and type of images in the identity verification process. Furthermore, the application data may comprise the type of images captured i.e. data from the identity documents required for the registration process.

For example, one type of application may require a first image (e.g. an image of an identity document, data stored on a chip of the identity document which is indicative of a digital image and/or identity or biometric information associated with the digital image) and a second image (e.g. an image of a user) to be captured. Another type of application may require a first image (e.g. an image of an identity document, such as a driving license), a second image (e.g. an image of a user) and a third image (e.g. an image of another identity document, such as a passport, data stored on a chip of the identity document which is indicative of a digital image and/or identity or biometric information associated with the digital image) to be captured.

Furthermore, the application data may comprise a flow configuration, which determines user journey or flow of the application i.e. the journey of the user through the application. Specifying the journey of the user through the application gives the third-party service 502 a greater degree of control and configurability of the application. For example, the third-party service may choose a flow configuration that first requests an image of the user and then requests an image of, or digital data from, an identity document, such as a driving license. In another example, the third-party service may choose a flow configuration that first asks for an image of, or digital data from, an identity document, such as a passport. Second, the flow configuration may ask for an image of another identity document, such as a bank statement or utility bill, and finally the flow configuration may ask for an image of the user. The flow configuration may also obtain further data such as location information from a satellite navigation system accessible by the device.

In some arrangements, the application data may comprise URI validity information, which defines the times for which the uniform resource identifier (URI) is valid. The validity information may contain a first timestamp from which the URI is valid. If a first timestamp is provided, the identity verification service may generate a URI that is valid from the first timestamp i.e. the user will only be able to perform the identity verification process after a time indicated by the first timestamp. If the first timestamp is not provided, then the identity verification service may generate a URI that is valid immediately i.e. the user can click on the URI to perform the identity verification process immediately. Furthermore, the validity information may contain a second timestamp until when the URI is valid. If a second timestamp is provided, the identity verification service may generate a URI that is valid only until a time indicated by the second timestamp i.e. the user will only be able to perform the identity verification process until the time of the second timestamp. If the second timestamp is not provided, then the identity verification service may generate a URI that is valid indefinitely i.e. the user can click on the URI to perform the identity verification process at any time.

The application data may comprise a usage allowance, which specifies how many times the URI may be clicked on to configure the application. By specifying the usage allowance, the third-party service can limit the number of times the application is configured/downloaded. If the usage allowance is not provided, there is no restriction of the number of times the application is configured/downloaded.

In order to track usage of the identity verification process, the application data may comprise a transaction allowance, which specifies how many times the identity verification process may be completed before the URI is deactivated. By specifying the transaction allowance, the third-party service can limit the number of times a user performs the identity verification process. After reaching the specified transaction allowance, the URI will be deactivated. If the transaction allowance is not provided, there is no limit on the number of times the user can perform the identity verification process.

Preferably, the application data may comprise a redirection uniform resource identifier (redirection URI). The redirection URI may be a uniform resource locator (e.g. a web address) associated with the third-party service 502. Upon completion of the identity verification process, the device of the user may be redirected to a website of the third-party service. The redirection URI provides a way of automatically navigating the user back to the third-party service 502, once the identity verification process has been performed. The user does not need to exit the application and manually navigate to the third-party service for which they have registered. Instead, the user is automatically navigated to a website of the third-party service 502.

Additionally, the application data may comprise further information associated with the third-party service, which is to be displayed in the application. For example, the further information may contain a privacy policy, terms and conditions and contact details for the third-party service. Such further information provides the user with customised information for the third-party service.

Providing the ability for the third-party service 502 to specify the user number and define the application data in such detail gives the third-party service a degree of control over how the application is configured. As a result, the third-party service 502 can provide a highly customised registration service to their users.

Suitable parameters for the above-mentioned application data of the first configuration data 512 include the following:

| | |
|---|---|
| app_id | Defines which application should be installed. |
| flow_configuration | Defines the flow of the application. |
| logo | Sets the logo for the application. The logo |
| | can be provided as image data or a URI. |
| colour_way | Sets the colourway for the application. |
| valid_from | The timestamp from which the URI is valid. |
| | If not specified, the URI is immediately valid. |
| valid_until | The timestamp until the URI is active/usable. If |
| | this is not specified, the validity is indefinite. |
| number_of_usage_ | The number of times the URI can be |
| allowed | downloaded. If not set, there is no restriction on |
| | the number of usages. |
| number_of_completed_ | The number of completed transactions that can |
| transactions_allowed | occur before the URI becomes deactivated. |
| target_user_id | Clicking the URI, the customer will be |
| | automatically logged as the target_user_id. |
| consumerRef | Sets the ConsumerRef to be used by the |
| | application, when creating the transaction. |
| transactionRef | Sets the transactionRef to be used by the |
| | application, when creating the transaction. |
| | If not set, the application will not set a |
| | transactionRef. |
| defaultLanguage | The language the system should default in. |
| exit_message_title | If defined, the exit message's title will be |
| | overwritten with this value. |
| exit_message_body | If defined, overrides the exit message body. |
| welcome_message_title | If defined, provides a custom title message that |
| | will be displayed on the first screen. |
| welcome_message_ | If defined, provides a custom message that will |
| body | be displayed on the first screen. |
| relay_state | This is a URI where the end-user can be |
| | redirected. |
| privacy_policy_url | The privacy policy will be displayed on the |
| | app. |
| terms_and_conditions_ | The terms and conditions that will be displayed |
| url | on the app. |
| contact_email | The is the contact email address displayed on |
| | the Accept privacy screen. |

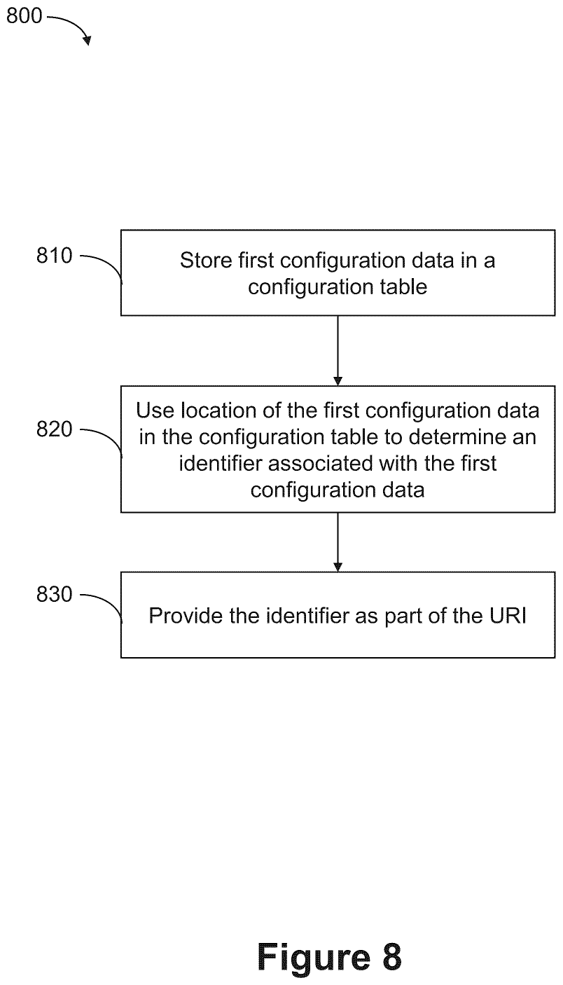

Preferably, the first configuration data 512 may be received from the third-party service 502 via an application programming interface. The application programming interface provides an interface between the identity verification service 501 and the third-party service 502. Referring also back to FIG. 6a, when the first configuration data 512 is received 510, the application programming interface returns a URI. Accordingly, in step 720 of the method 700, the first configuration data 512 is used to generate 514 a uniform resource identifier (URI) 518 for an application associated with the identity verification process. Details of the generation of the URI will be later described with reference to FIG. 8.

In step 730 of the method 700, the URI is sent 516a to the third-party service 502 to provide to a device associated with the user. The URI may be provided to the third-party service via an application programming interface, as explained above.

The third-party service 502 may then provide 516b the URI to the device 410 associated with the user. The URI 516 may be sent 520 to the device from the third-party service using a messaging service, such as a short message service (e.g. SMS) or an email service.

In order to provide the URI to the device associated with the user, the third-party service 502 needs to determine contact data (i.e. contact details) for the user. The third-party service 502 may perform a query or request to a database that contains user numbers and associated contact data such as email address information for the user. Upon determination of the contact data for the user, the URI is sent to the device. For example, as described above, the mobile phone number can be used to send a text message containing the URI to the device of the user, or the email address can be used to send an email containing the URI to the user.

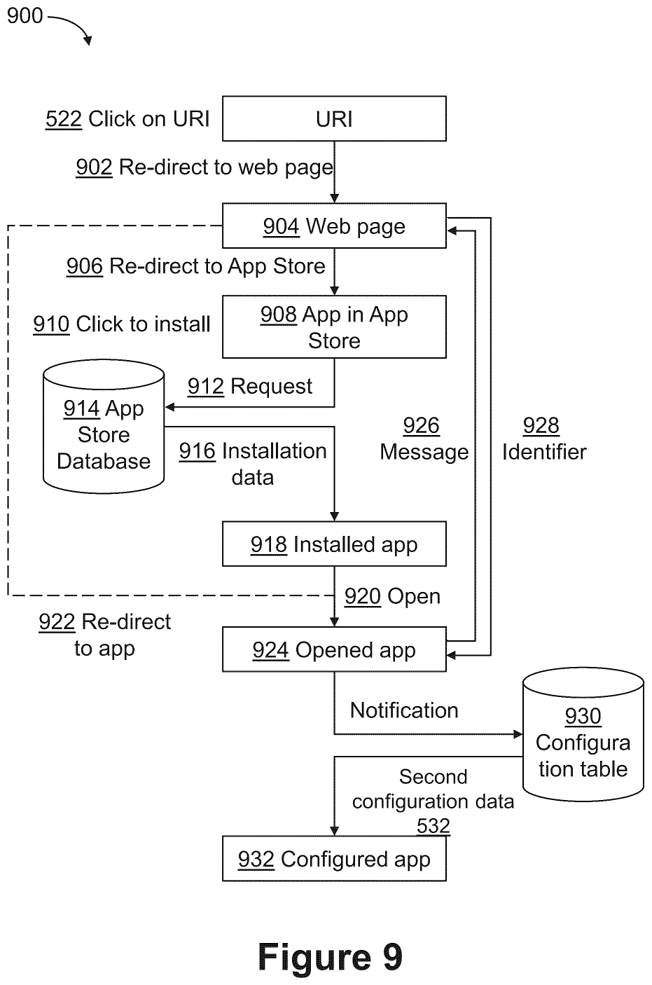

In step 740 of the method 700, a notification 526 is sent 524 by the device 410 indicating that the user has accessed the URI. Accessing the URI initiates the download, installation and/or configuration of the application on the user's device, so that the user can perform the identity verification process. Details of the installation and configuration of the application associated with the identity verification process will be later described with reference to FIG. 9.

In some arrangements, the notification 526 is sent by the user's device once the application is invoked, which may be triggered in response to the user accessing the URI. In other arrangements, the notification is sent when the user clicks 522 on the URI. In yet other arrangement, the notification 526 is sent by the user's device when the application is opened.

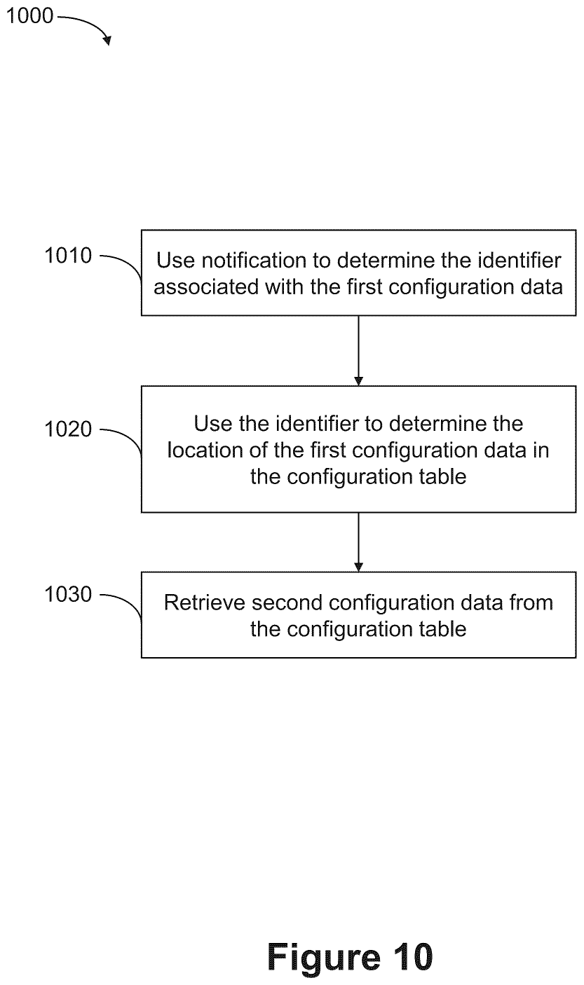

In each case, responsive to receipt of the notification message 524, the identity verification service 501 retrieves 528 second configuration data 532. Details of the retrieval of the second configuration data will be later described with reference to FIG. 10.

In step 750 of the method 700, the identity verification service 501 sends 530 second configuration data 532 to the device 410. When the second configuration data 532 is received by the device 410, the application is installed and/or opened and configured 534 on the device. In the case where the application is not already installed on the device 410, the application is first downloaded to the device 410, e.g. via a download service on the device 410 by means of a suitable call to the operating system resources of the device 410. In the case where the application is already installed on the device 410, the installed application is configured using the second configuration data 532. Once the application is configured on the device 410, the user may perform 536 an identity verification process.

In some arrangements, upon completion of the identity verification process by the user on the device, the downloaded and configured application may send 538 an identity verification outcome 540 to the identity verification service 501. The identity verification outcome 540 indicates the outcome of the identity verification process i.e. whether the identity verification process has succeeded or failed. If the user has passed the identity verification process (for example, the identity verification service 501 determines that the first and second images represent the same user), then the identity verification outcome 538 will indicate the success of the process. In other words, the identity of the user has been verified. If the user has failed the identity verification process (for example, the identity verification service determines that the first and second images do not represent the same user), then the identity verification outcome 540 will indicate the failure of the process.

Upon receipt of the identity verification outcome 540, the identity verification service 501 sends 542 an outcome notification 544 to the third-party service 502, notifying the third-party service 502 of the outcome of the process. If the user has passed the identity verification process, the third-party service 502 may then register 550 the user with the third-party service. If the user has failed the identity verification process, the third-party service may provide the user with alternative options on how to proceed. For example, the user may be invited to perform the identity verification process again, perform the identity verification process using a different first captured image and/or second captured image etc.

The device may not send an identity verification outcome to the identity verification service. Instead or in addition, the application may automatically direct the device, via the redirection URI, back to the third-party service 502. This gives the third-party service 502 the option to provide further services to the user. Alternatively the device 410 can be directed to other resources. Further details are described later in the description.

FIG. 8 is a flow diagram illustrating a method 800 for generating a URI associated with an application. The URI is generated by the identity verification service 501 upon receipt of first configuration data 512 from the third-party service 502.

In step 810 of the method 800, the first configuration data is stored in a configuration table. The first configuration data, comprising a user number and application data, may be stored in a configuration table, such as a data table, data structure or database, by the identity verification service. The configuration table may be stored by the identity verification service on a data storage server.

In step 820 of the method 800, a location of the first configuration data in the configuration table is used to determine an identifier. The identifier is associated with the first configuration data. The location of the first configuration data in the configuration table uniquely identifies the first configuration data stored in the configuration table. As such, the identifier (determined from the location) also uniquely identifies the first configuration data. The identifier, which may be referred to as a unique number identifier, can be used to quickly and efficiently access the first configuration data in the configuration table. In some arrangements, the configuration table acts as a hash table, whereby the identifier is the key to access the associated data i.e. the first configuration data. For example, the identifier may be ‘uid-abcd1234’, which uniquely identifies particular first configuration data stored in the configuration table.

In step 830 of the method 800, the identifier is provided as part of the URI. A first part of the URI may be a generic web address that indicates a location from which the application can be downloaded. For example, the first part of the URI may be ‘https://apps.apple.com/app/paycasso/’. A second part of the URI may be the identifier, which uniquely identifies the first configuration data for the user. As a result, the identifier uniquely identifies the application to be downloaded by the user. For example, the second part of the URI may be ‘uid-abcd1234’. As a result, the URI generated by the identity verification service and provided to the third-party service may take the form of a uniform resource location (URL), e.g. ‘https://apps.apple.com/app/paycasso/uid-abcd1234’.

In order to shorten the URL sent to the user, the uniform resource locator may be shortened using a URL shortening technique. As a result, the URL sent to the user may be substantially shorter but will still direct the user to the intended location. Shortening the URL sent to the user may have multiple benefits. For example, a short URL may make the URL more manageable for the third-party service 502 to share with the user. In addition, a short URL may be beneficial when the URL is sent to a user via a communication method that limits the amount of data sent. For example, a text message, which limits the number of characters to 160 characters, may be used to send the URL to the user. Shortening the URL, often to less than 20 characters, allows the third-party service at least 140 characters to provide to the user any additional information required.

Preferably, an application programming interface may be used to generate the URI. For example, using a ‘api/url-service/create’ command alongside the first configuration data 505 (received from the third-party service 502), the identity verification service 501 generates the URI.

FIG. 9 is a schematic diagram illustrating a method 900 for configuring an application associated with an identity verification process according to an example. The process of configuring the application may begin when a user clicks 522 on a URI in order to initiate the identity verification process and register with the third-party service.

Selecting 522 the URI, e.g. by clicking on the URI causes the application to be downloaded, installed, opened and configured on the device 410 of the user. In some arrangements, opening the application will initiate sending of a notification to the identity verification service to start the configuration of the application. If the user already has the application installed on the device, clicking the URI may just open the application on the device, to start the configuration process.

Clicking 522 on the URI causes the operating system of the device to redirect 902 to a web page 904, associated with the identity verification service. Upon loading, the web page 904 may perform several actions. The web page 904 may determine characteristics of the device e.g. type of device, operating system, presence of installed applications etc. Such a determination allows the web page 904 to determine how to proceed with configuring the i.e. how to direct the operating system to install and/or configure the application. The web uniform resource locators (URL) to redirect the operating system of the device to an appropriate location, in order to install and/or configure the application, depending on the determined characteristics of the device.

In some embodiments, the web page 904 stores information associated with the URI, such as a cookie. For example, the identifier associated with the URI. The identifier acts to identify the URI that has been clicked on by the user and the configuration data associated with the user. In some arrangements, the web page 904 may store the number of times the URI is clicked on, in order for the identity verification service to keep track of how many times the URI is be clicked on to configure the application.

Upon determination of the type of device, the web page 904 redirects the operating system of the device accordingly. If the device is a mobile device, the web page 904 can redirect the operating system of the device to an app store (if the application is not already installed) or directly to the application (if the application is already installed). For example, the app store could be the Apple App Store or the Google Play Store. If the device is a laptop, the web page 904 can redirect the operating system of the device to a web application on a web browser on the device. Alternatively, the web page 904 may redirect the operating system of the laptop to an app store (such as the Apple Mac App Store or the Microsoft Store) or directly to the application.

Two examples are provided, in order to describe a few of the possible ways in which the application can be configured. In a first example, the web page 904 may determine that the device is a mobile device (e.g. an iPhone) that is running an iOS operating system, without the application already installed. The web page 904 may use a redirection URI that redirects the operating system of the device to the application. In some arrangement, the web page 904 may store information associated with the URI, such as the identifier in a cookie associated with the web page 904. As the device does not have the application installed, the redirection URI will redirect 906 the operating system to the location of the application on a download service (following the solid black line 906 of the method 900 from the web page 904 to the application 908 in the App Store). In this first example, as the operating system is an iOS, the download service is the Apple App Store. Upon navigation to the application 908 in the App Store, the user may be invited to install the application. Upon selection 910 of the relevant icon to install the application, the device sends a request 912 to the App Store database 914 (or server) which returns installation data 916 to the device. The installation data 916 (associated with the application) is then downloaded from the App Store database 914 onto the device, installing the application on the device and creating an installed application 918. Upon installation, the installed application 918 may automatically open 920 on the device. In alternative arrangements, the user may be required to open the installed application 918 on the device.

In a second example, the web page 904 may determine that the device is a mobile device that is running an Android operating system (e.g. a Google Pixel™ mobile phone), with the application already installed. The web page 904 may use a redirection URI that redirects the operating system of the device to the application. As the device already has the application installed, the redirection URI will redirect 922 the operating system to the application on the device (following the dashed black line 922 of the method 900 from the web page 904 to the opened application 924). As such, the redirection URI avoids navigating the operating system to the location of the application on a download service (e.g. the Google Play™ Store), and instead navigates directly to the application 924 on the device.

Via either navigation route, once opened, the opened application 924 is then configured so that the user can perform the identity verification process. For example, the configuration of the application is performed during the initial loading of the application i.e. when the loading or ‘splash’ screen is displayed. Upon opening, the opened application 924 sends a message 926 to the web page 904. The message 926 contains a request for the identifier 928 stored by the web page 904. As described above, the identifier 928 is associated with the first configuration data, which allows the first configuration data stored in the configuration table 930 to be uniquely identified. Upon receipt of the message 926 by the web page 904, the web page 904 provides the identifier 928 to the device i.e. the opened application 924.

Upon receipt of the identifier 928, the device sends a notification to the identity verification service in order to request configuration data for the application. More specifically, the notification contains the identifier 928, which allows the first configuration data in the configuration table 930 to be identified. Using the identifier 928, second configuration data 532 is retrieved from the configuration table 930.

Preferably, an application programming interface is used to retrieve the second configuration data 532. For example, a ‘api/url-service/get’ command is used with the identifier 928, which causes the identity verification service 501 to retrieve the second configuration data 532 from the configuration table 930.

In some arrangements, the configuration table may be used to store the number of times the URI is clicked on i.e. the usage allowance. As such, the identity verification service is able to keep track of how many times the URI is be clicked on to configure the application usage. Similarly, the configuration table may be used to store the number of times the identity verification process is completed i.e. the transaction allowance. As such, the identity verification service is able to keep track of how many times the user has performed the identity verification process.

The second configuration data 532 is then sent to the device, more specifically to the application installed on the device, in order to configure the application. Using the second configuration data, the application is configured to create a configured application 932 for the user to perform the identity verification process associated with the third-party service.

In some arrangements, the second configuration data 532 is stored in the dynamic memory of the device for the duration of the identity verification process. By storing the second configuration data 532 in dynamic memory, the application is only configured for the identity verification process associated with the third-party service for the time it takes for the user to complete the identity verification process. As such, when the user has completed the identity verification process, the second configuration data is deleted from dynamic memory, resulting in the application returning to its standard or default configuration. In such an arrangement, the application is only configured for the identity verification process associated with the third-party service for a single user journey through the application. Upon completion of the identity verification process for registration with the third-party service, the user can then continue to use the application in its default configuration.

FIG. 10 is a flow diagram illustrating a method 1000 for retrieving configuration data according to an example such as is shown in FIG. 6a. Second configuration data is retrieved by the identity verification service upon receipt of a notification 526 that is sent 524 from a device 410 associated with a user. The notification comprises information extracted from the URI, in particular an identifier that uniquely identifies first configuration data for the application for that user.

Accordingly, in step 1010 of the method 1000, upon receipt of the notification from the device, the identity verification service 501 determines the identifier associated with the first configuration data. Following on from the previous example described in FIG. 8, the identifier may be ‘uid-abcd1234’.

In step 1020 of the method 1000, the identifier is used to determine the location of the first configuration data in the configuration table. The identifier may be used as a key to access the associated first configuration data. Providing the identifier ‘uid-abcd1234’ allows associated configuration data to be accessed from the configuration table.

In step 1030 of the method, second configuration data is retrieved from the configuration table. More specifically, using the location of the first configuration data in the configuration table, a subset of the first configuration data—in the form of the stored application data—is retrieved as second configuration data532, and sent to the device 410. The second configuration data is then used to configure the application for the identity verification process.

In some arrangements, an application programming interface may be used to retrieve the second configuration data 532. For example, the notification message may comprise a ‘api/url-service/get’ command alongside the identifier, which causes the identity verification service 501 to retrieve the second configuration data 532.

The redirection by the URI via the web page 904 to the application and the determination of the identifier 928 to retrieve the second configuration data 532 is preferably implemented by means of deferred deep linking techniques in order to configure the application. As such, the second configuration data 532 links to a specific location and/or configuration within the application, instead of launching the application with a default location or configuration. As a result, the installed application is automatically configured based on the second configuration data 532 and the user may proceed to perform the identity verification process.

FIG. 11 is a flow diagram illustrating a method 1100 performed by a third-party service 502 according to an example such as is shown in FIG. 6a. In step 1110 of the method 1100, the first configuration data is sent to the identity verification service 501. The first configuration data comprises a user number associated with the user of the third-party service and application data associated with the third-party service.

Preferably, the third-party service 502 sends the first configuration data 512 to the identity verification service 501 via an application programming interface. As described above with reference to FIG. 8, the third-party service 502 may provide the first configuration data to the application programming interface with a ‘api/url-service/create’ command. Using the application programming interface, the identity verification service 501 generates a URI.

In step 1120 of the method 1100, a URI is received from the identity verification service 501. The URI includes data corresponding to an application associated with the identity verification process.

In step 1130 of the method 1100, the URI is provided to a device 410 associated with the user. Providing the URI allows the user to perform the identity verification process to register with the third-party service 502.

FIG. 12 is a flow diagram illustrating a method 1200 performed by a device 410 associated with a user of a third-party service 502.

In step 1210 of the method 1200, a URI is received from the third-party service 502. The URI includes data corresponding to an application associated with the identity verification process. The URI may be received by a device 410 associated with the user via a messaging service, such as a short message service or an email service. The URI may be received as part of a text message, an email or other such communication.

In step 1220 of the method 1200, on the URI is clicked on to initiate configuration of the application on the device. In step 1230 of the method 1200, a notification 524 is provided to the service 501.

As described above, in some arrangements, in response to selecting by e.g. clicking on the URI, the device may navigate to a download service. The application may then be downloaded from the download service. For example, the download service may be the Apple App Store or the Google Play Store, which initiates installation of the application via the download service. Once the application is installed, the application automatically opens on the device. In response to the user clicking on the URI or in response to the opening of the application on the device, the device receives second configuration data from the identity verification service 501.

Accordingly, in step 1240 of the method 1200, second configuration data 532 is received to configure the application in order to perform the identity verification process to register with the third-party service. Once the application is configured, the application can be used to perform the identity verification process, in order to register to the user with the third-party service. Furthermore, once the identity verification process has been successfully performed (and the identity of the user verified) the user may be considered to be registered with the third-party service.

The provisioning of the first and second configuration data 532 to the device 410 may be part of a relay process whereby the device 401 is provisioned with a set of different configuration data, each of which configures the device to access different applications and/or remote services. The provisioning of the first and second configuration data in the manner described above with reference to FIGS. 6a-12 may be considered to be an initial part of the relay process, and followed by provisioning third (and possibly further) configuration data (not shown) to the device 401.

The provisioning of third configuration data can be invoked when the user completes the identity verification process and thus in conjunction with, or separate from, steps 542 and 546 described above with reference to FIG. 6b. In one example the image verification service 501 can send third configuration data in response to the identity verification outcome message sent at step 542. The third configuration data identifies, e.g. by means of a pointer to, a resource that is to be accessed by the device 410, dependent upon the identity verification outcome. For example, if the identity verification is positive, the pointer may be a URL to e.g. a website associated with the third party service 502. Alternatively, it may make use of deep linking techniques in the form of an Universal Link or App2app message, causing an application to be downloaded and/or launched on the device 401 using e.g. OAuth2 or OpenID Connect. The third configuration data may include the relevant credential information to enable inter-app communication. This enables the user to access functionality of the third party service 502 for which he has been verified without having to separately and manually bring up a web page or launch an application. If the identity verification is negative, the pointer may reinitialise (or refresh) the second configuration data so as to recommence the identity verification process.

This effectively provides a relay mechanism that enables a user to access a nested set of resources. Each resource is defined by respective configuration data, which can be independently and dynamically updated. The relay mechanism avoids a need to include all configuration data that may, or may not, by utilized during the relay process at the start (which is to say as part of the first process, and thus in the first configuration data), and instead makes it available as and when a user progresses through the verification and service access processes. Another benefit is that changes can be made to respective resources without having to restart the entire process.

The above embodiments are to be understood as illustrative examples of the disclosure. Further embodiments are envisaged. For example, while implementing the relay approach has the advantages set out above, it is to be appreciated that the second and/or third configuration data may be sent with the first configuration data. Furthermore, it is to be appreciated that the second and subsequent sets of configuration data may logically be stored as a subset of the first configuration data.

As an alternative to configuring a mobile application to perform the identity verification process, the application may be a web application. The uniform resource identifier (URI) generated by the identity verification service may be associated with a web application, instead of a mobile application. For example, the URI may take the form of a uniform resource locator (URL). As a result, when the URL is clicked on by the user, instead of navigating to an App Store (to download and install a mobile application), the URL navigates to a web application on a web browser on the device. The web application may then be configured to perform the identity verification process, associated with the third-party service. Conveniently, the user is not required to install any application on their device, instead the user may perform the identity verification process via their web browser.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the disclosure, which is defined in the accompanying claims.

Although at least some aspects of the embodiments described herein with reference to the drawings comprise computer processes performed in processing systems or processors, the disclosure also extends to computer programs, particularly computer programs on or in a carrier, adapted for putting the teaching of this disclosure into practice. The program may be in the form of non-transitory source code, object code, a code intermediate source and object code such as in partially compiled form, or in any other non-transitory form suitable for use in the implementation of processes according to the teaching of this disclosure. The carrier may be any entity or device capable of carrying the program. For example, the carrier may comprise a storage medium, such as a solid-state drive (SSD) or other semiconductor-based RAM; a ROM, for example a CD ROM or a semiconductor ROM; a magnetic recording medium, for example a floppy disk or hard disk; optical memory devices in general; etc.

It will be understood that the processing system referred to herein may in practice be provided by a single chip or integrated circuit or plural chips or integrated circuits, optionally provided as a chipset, an application-specific integrated circuit (ASIC), field-programmable gate array (FPGA), digital signal processor (DSP), etc. The chip or chips may comprise circuitry (as well as possibly firmware) for embodying at least one or more of a data processor or processors, a digital signal processor or processors, baseband circuitry and radio frequency circuitry, which are configurable so as to operate in accordance with the exemplary embodiments. In this regard, the exemplary embodiments may be implemented at least in part by computer software stored in (non-transitory) memory and executable by the processor, or by hardware, or by a combination of tangibly stored software and hardware (and tangibly stored firmware).

What is claimed is:

1. A method of registering a user with a third-party service using an identity verification process, wherein the method is performed by a processing system comprising at least one processor and at least one memory, and comprises:
receiving configuration data from the third-party service, wherein the configuration data comprises:
a user number associated with the user of the third-party service; and
application data associated with the third-party service,
using the configuration data to generate a uniform resource identifier for an application associated with the identity verification process;
distributing the URI to a device associated with the user;
receiving a notification from the device indicating that the user has accessed the URI; and
responsive to the notification, sending at least part of the configuration data to configure the application on the device in order for the user to perform the identity verification process, associated with the third-party service, to register with the third-party service.

2. A method according to claim 1, further comprising:
receiving an identity verification outcome from the identity verification process performed by the user; and
notifying the third-party service of the identity verification outcome.

3. A method according to claim 1, wherein generating the uniform resource identifier comprises:
storing the configuration data in a configuration table;
using a location of the configuration data in the configuration table to determine an identifier associated with the configuration data; and
providing the identifier as part of the uniform resource identifier.

4. A method according to claim 3, further comprising:
upon receipt of the notification from the device, using the notification to determine the identifier associated with the configuration data;
using the identifier to determine the location of the configuration data in the configuration table; and
retrieving the configuration data from the configuration table.

5. A method according to claim 1, wherein distributing the uniform resource identifier comprises providing the uniform resource identifier to at least one of the third-party service and the device associated with the user.

6. A method according to claim 1, wherein the application data comprises at least one of a message, a logo, an identity document, a choice of language or a redirection uniform resource identifier associated with the third-party service.

7. A method according to claim 1, wherein receiving configuration data from the third-party service comprises receiving configuration data via an application programming interface.

8. A method according to claim 1, wherein configuring the application causes the application to be downloaded on to the device associated with the user.

9. A method according to claim 1, wherein, when the application is already installed on the device, the method comprises causing the installed application to be updated based on at least part of the configuration data sent to the device associated with the user.

10. A method according to claim 1, wherein providing the uniform resource identifier to the third-party service further comprises:
providing, by the third-party service to the device associated with the user of the third-party service, the uniform resource identifier.

11. A method according to claim 10, further comprising:
using the user number to determine, by the third-party service, contact data associated with the user of the third-party service;
using the contact data associated with the user to provide the uniform resource identifier to the device.

12. A method according to claim 1, further comprising registering the user with the third-party service based on the result of the identity verification process.

13. A processing system comprising at least one processor and at least one memory for use in registering a user of a third-party service using an identity verification process, the service being configured to:
receive configuration data from the third-party service, wherein the configuration data comprises:
a user number associated with the user of the third-party service; and
application data associated with the third-party service;
use the configuration data to generate a uniform resource identifier for an application associated with the identity verification process;
distribute the uniform resource identifier to a device associated with the user;
receive a notification from the device indicating that the user has accessed the uniform resource identifier; and
responsive to the notification, send at least part of the configuration data to configure the application on the device in order for the user to perform the identity verification process, associated with the third-party service, to register with the third-party service.

14. A non-transitory computer-readable storage medium comprising a set of computer-readable instructions stored thereon, which when executed by at least one processor and at least one memory cause the at least one processor to register a user of a third-party service using an identity verification process by:
receiving configuration data from the third-party service, wherein the configuration data comprises:
a user number associated with the user of the third-party service; and
application data associated with the third-party service,
using the configuration data to generate a uniform resource identifier for an application associated with the identity verification process;
distributing the URI to a device associated with the user;
receiving a notification from the device indicating that the user has accessed the URI; and
responsive to the notification, sending at least part of the configuration data to configure the application on the device in order for the user to perform the identity verification process, associated with the third-party service, to register with the third-party service.
